(19) United States
(12) Patent Application Publication
(10) Pub. No.: US 2013/0151416 A1
(43) Pub. Date: Jun. 13, 2013

(54) SYSTEM AND METHOD FOR TARGETED INFORMATION DELIVERY THROUGH SOCIAL NETWORK

(71) Applicants: Ka Ka NG, Hong Kong (HK); Mang Yan FUNG, Hong Kong (HK); Ching Yin LAM, Hong Kong (HK)

(72) Inventors: Ka Ka NG, Hong Kong (HK); Mang Yan FUNG, Hong Kong (HK); Ching Yin LAM, Hong Kong (HK)

(73) Assignee: Red Soldier Limited

(21) Appl. No.: 13/562,340

(22) Filed: Jul. 31, 2012

Related U.S. Application Data
(60) Provisional application No. 61/569,791, filed on Dec. 13, 2011.

(51) Int. Cl. G06Q 30/02; G06Q 20/36

(52) U.S. Cl. 705/65; 705/14.66

(57) ABSTRACT

A method for delivering information to a targeted group of users includes establishing a network that includes a plurality of users and a plurality of entities being connected with each other based on the interest of the users in the entities; searching for a targeted group of users who match a specification of an interest profile and a specification of a spatial temporal profile among the users in the network; and delivering information to the targeted group of users. The interest profile is based on the relationships between each user and the entities that the user is interested in. The spatial temporal profile is based on the location and the time on which the user accesses the network. A system for delivering information to a targeted group of users is also provided.

### CROSS-REFERENCE TO RELATED APPLICATIONS

This application claims the benefit of U.S. Provisional Application No. 61/569,791, filed on Dec. 13, 2011; the contents of which is hereby incorporated by reference.

### FIELD OF THE PATENT APPLICATION

The present patent application generally relates to the field of social network and business advertising on social network and more specifically to a system and a method for targeted information delivery through a people-thing-people mobile social network.

### BACKGROUND

Social networks help people maintain relationships and get latest updates from the others.

Most social networks focus on modeling the people-to-people relationship. People have friends, and through their existing friends on the social network, they can know new friends by knowing friends' friends and extend their social network.

However, there is another kind of social network not based on the people-to-people relationship. It is based on the relationship between people and things. A thing can be any entity that exists in the real world. It can be a particular place, a restaurant, a cafe, a hotel, an event, a movie, a book, a brand, a product, a cartoon character, an organization, an idea, an activity, a hobby and etc.

For a thing that people are caring about and interested in, they can form relationships on the social network. With such relationships being formed, the users can get the latest updates, news from the network about that entity, including other users' activities with that entity.

When there are other users being interested in the same thing, they can also form relationships with that entity. People having relationship with the same entity can interact and collaborate through that entity.

There are people interested in the same entity, and there are entities that the same person is interested in. All these relationships together form the People-Thing-People social network.

On social networks, in general, there is a growing trend for marketers to push advertisements to the network members. However, there is often a conflict between the marketers and the users. Marketers want to push as more advertisements as possible to more users, while the users only want to consume content that they are interested in and have fewer advertisements. As a result, the marketers are often wasting efforts and resources to push advertisements to the wrong or un-targeted group of users who are not interested in them, while users find it annoying when they keep receiving advertisements non-relevant to them.

In addition to the online marketers' need, real-world stores also have a need to find consumers online and bring them to the business. This is so called the “online-to-offline commerce”, or “O2O commerce”, which is made possible by the mobile Internet and the popularity of mobile devices.

### SUMMARY

The present patent application is directed to a method and a system for delivering information to a targeted group of users. In one aspect, the method includes establishing a network that includes a plurality of users and a plurality of entities being connected with each other based on the interest of the users in the entities; searching for a targeted group of users who match a specification of an interest profile and a specification of a spatial temporal profile among the users in the network; and delivering information to the targeted group of users. The interest profile is based on the relationships between each user and the entities that the user is interested in. The spatial temporal profile is based on the location and the time on which the user accesses the network.

The method may further include claiming ownership of an owned entity within the network.

The method may further include establishing a targeted group specification. The targeted group specification includes the specification of the interest profile and the specification of the spatial temporal profile. The entities in the specification of the interest profile include an owned entity. If a user has relationships with all entities in the specification of the interest profile, then the user matches the specification of the interest profile. The specification of the spatial temporal profile may be represented by a geographical grid, a time interval, and a threshold value. If a user has accessed the network at the geographical grid during the time interval for a number of times that is equal to or greater than the threshold value, then the user matches the specification of the spatial temporal profile.

The method may further include assigning an electronic credit to a user connected to the owned entity. The method may further include assigning an additional electronic credit to the user if the user performs a predetermined action.

The method may further include assigning a queue token with a token number to a user connected to the owned entity. The method may further include sending an alert to the user when the difference between the token number currently being served and the token number of the user is within a predetermined threshold. The method may further include sending another alert to the user when the token number currently being served is equal to the user's token number.

In another aspect, the present patent application provides a system for delivering information to a targeted group of users. The system includes a first persistence store configured to store relationships between a plurality of users and a plurality of entities forming a network; a second persistence store configured to store the location, the time, and the number of times for each of the users accessing the network; a first engine and a second engine respectively configured to search for a group of users who match a specification of an interest profile and a specification of a spatial temporal profile in the network; and a network layer configured to deliver information to a targeted group of users. The targeted group of users match both the specification of the interest profile and the specification of the spatial temporal profile. The interest profile is based on the relationships between each user and the entities that the user is interested in. The spatial temporal profile is based on the location and the time on which the user accesses the network.

The specification of the interest profile may include at least one owned entity owned by a merchant. If a user has relationships with all entities in the specification of the interest profile, then the user matches the specification of the interest profile.

The specification of the spatial temporal profile may be represented by a geographical grid, a time interval, and a threshold value. If a user has accessed the network at the geographical grid during the time interval for a number of times that is equal to or greater than the threshold value, then the user matches the specification of the spatial temporal profile.

The system may further include a logic unit configured for executing logics and a distributed memory configured for storing data required in computation or caching. The logic unit may be configured to assign an electronic credit to a user connected to the owned entity. The logic unit may be configured to assign a queue token with a token number to a user connected to the owned entity.

In yet another aspect, the present patent application provides a computer-readable medium storing thereon one or more instructions, which when implemented causes a processor to implement a method for delivering information to a targeted group of users. The method includes establishing a network that includes a plurality of users and a plurality of entities being connected with one another based on the interest of the users in the entities; searching for a targeted group of users who match a specification of an interest profile and a specification of a spatial temporal profile among the users in the network; and delivering information to the targeted group of users. The interest profile is based on the relationships between each user and the entities that the user is interested in. The spatial temporal profile is based on the location and the time on which the user accesses the network.

### BRIEF DESCRIPTIONS OF THE DRAWINGS

FIG. 1 illustrates a People-Thing-People mobile social network.

FIG. 2 illustrates modeling of a People-to-People social network as a graph with a single type of nodes, and modeling a People-Thing-People social network as a Bipartite Graph.

FIG. 3 shows how the relationships between a user and the things/entities form his/her Interest Profile, and how interaction between the user and the People-Thing-People mobile social network captures the user's locations with time which forms his/her Spatial Temporal Profile.

FIG. 4 is a flow chart showing the process of submitting users' contributions in terms of photos or comments, with or without the current GPS locations of the users.

FIG. 5 is a flow chart showing the process of a user joining the People-Thing-People mobile social network.

FIG. 6 illustrates how a user updates his/her Interest Profile, by removing and adding some relationships with things/entities.

FIG. 7 illustrates an example of how a location and time entry is transformed into a specific format of People-to-Spatial Temporal relationships that facilitates efficient querying by the Backward Discovery Technology.

FIG. 8 is a flow chart showing how a given pair of user's current GPS location and access time is used to fill in the People-to-Spatial Temporal relationships with a frequency count.

FIG. 9 shows that a merchant claims ownership of two entities which represent its real-world product/service.

FIG. 10 shows how a target group specification can be formed with an Interest Profile specification and Spatial Temporal Specification by a merchant.

FIG. 11 is a flow chart showing the process of locating a group of users with matched Interest Profile and Spatial Temporal Profile according to the targeted group specification.

FIG. 12 shows the overall architecture for both the mobile device, and the service that implements the People-Thing-People Social Network.

FIG. 13 is a flow chart showing the process for a user to get e-points or e-coupons and use the e-coupon.

FIG. 14 is a flow chart showing the process of how a user uses the e-queue system of an owned Thing.

### DETAILED DESCRIPTION

Reference will now be made in detail to a preferred embodiment of the system and the method for targeted information delivery through a social network disclosed in the present patent application, examples of which are also provided in the following description. Exemplary embodiments of the system and the method for targeted information delivery through a social network disclosed in the present patent application are described in detail, although it will be apparent to those skilled in the relevant art that some features that are not particularly important to an understanding of the system and the method for targeted information delivery through a social network may not be shown for the sake of clarity.

Furthermore, it should be understood that the system and the method for targeted information delivery through a social network disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

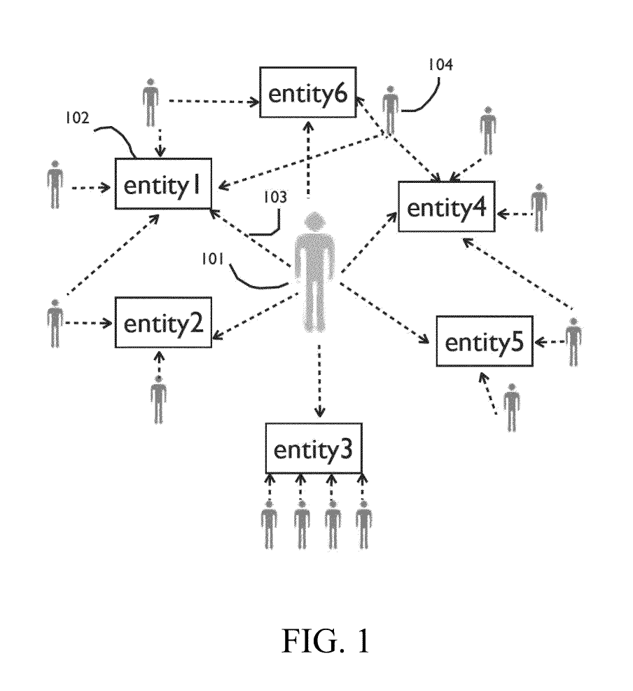

FIG. 1 illustrates a People-Thing-People mobile social network. Referring to FIG. 1, in a People-Thing-People social network, a user 101 finds or creates an entity 102 that he/she is interested in and cares about, and builds a relationship 103 with it. Once the entity 102 has been created in the network, it can be searched and found by other users. If there is another user 104 interested in this entity, he/she can also build a relationship with it. As illustrated in FIG. 1, the user 101 and the user 104 share a common interest for the entity 102. All these users, entities, and their relationships form the People-Thing-People Social Network.

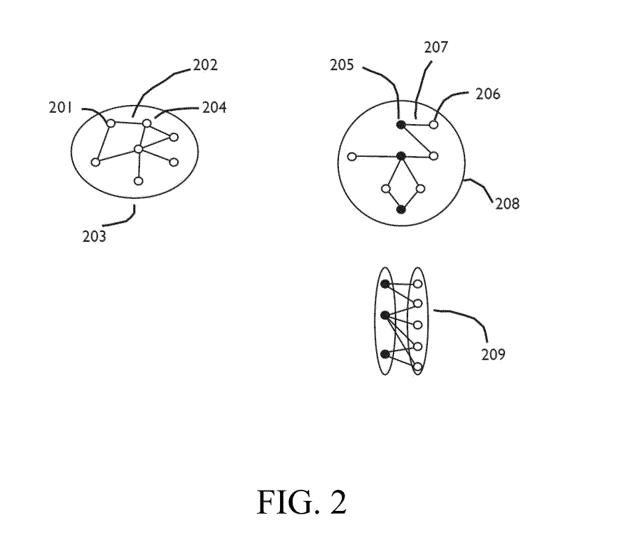

FIG. 2 illustrates modeling of a People-to-People social network as a graph with a single type of nodes, and modeling a People-Thing-People social network as a Bipartite Graph. Referring to FIG. 2, from the view of the graph theory, a People-to-People social network is a graph 203 composed by a set of nodes of a single type and the edges between them. Node 201 represents a user, node 204 represents another user. If they are friend to each other, they will form a relationship represented by the edge 202.

From the view of graph theory, a People-Thing-People social network is a bipartite graph 208 composed by two set of nodes of different types and the edges between the nodes of different types. No edge is allowed between the nodes of the same type. The node 205 represents a user, and the node 206 represents an entity. The edge 207 represents the relationship between the user and the entity. The bipartite graph 208 can be transformed to a representation 209, in which the nodes at one side represent the users and the nodes at another side represent entities. All the edges are connecting nodes from the one side to the other side and no edges are connecting nodes from the same side.

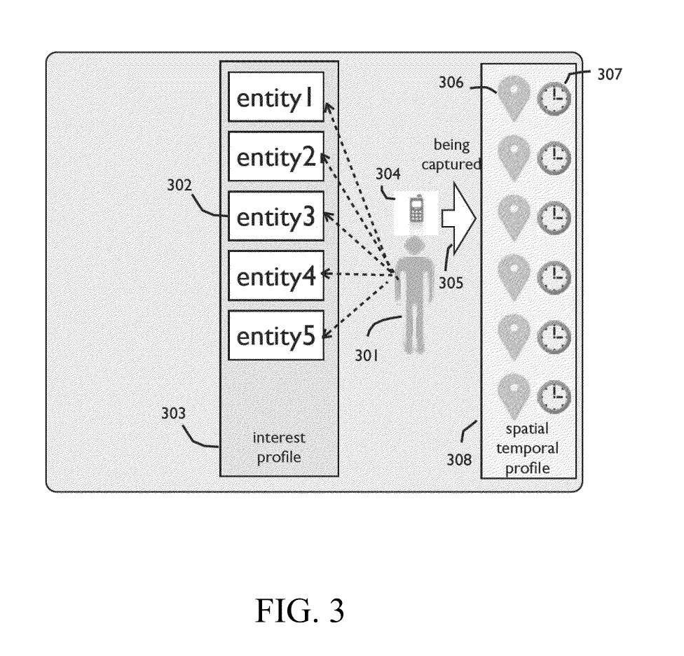

FIG. 3 shows how the relationships between a user and the things/entities form his/her Interest Profile, and how interaction between the user and the People-Thing-People mobile social network captures the user's locations with time which forms his/her Spatial Temporal Profile. On the People-Thing-People mobile social network, once a user 301 has built relationships with the entities he/she cares, this set of entities would form the user's interest profile 303. The entity 302 is one of the entities that the user 301 is caring about and has a relationship with, and therefore the entity 302 is in the interest profile of the user 301.

Referring to FIG. 3, the user 301 accesses the People-Thing-People mobile social network through his/her mobile device 304. If the device 304 is with GPS capabilities and the user 301 turns on this feature, the device 304 is configured to capture the location of the user 301, expressed as in GPS coordinates, and send it with the access time to the mobile social network through a network connection 305. The user's location 306 and the user's access time 307 will form a pair. All these pairs will be recorded and stored in the People-Thing-People mobile social network and form the user's spatial temporal profile 308.

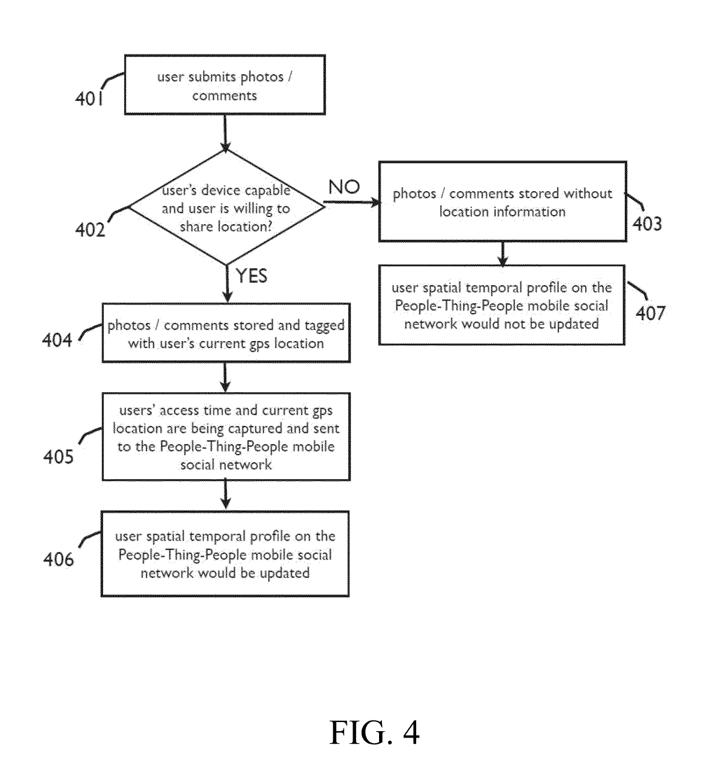

FIG. 4 is a flow chart showing the process of submitting users' contributions in terms of photos or comments, with or without the current GPS locations of the users. Referring to FIG. 4, when a user submits photos or comments as in 401, if the device is capable of retrieving the users' current GPS location, the user would be prompted to ask if he/she is willing to share the location to the People-Thing-People mobile social network as in 402. If he/she does not want to, the photos or comments will be sent without any GPS location and the People-Thing-People mobile social network will have no record for the GPS location of these submitted photos and comments as in 403, and will not update user's spatial temporal profile as in 407. If the user is willing to share his/her current location, the submitted photos or comments will be stored with the user's current location in the People-Thing-People mobile social network as in 404. The People-Thing-People mobile social network will also store the user's access time and current GPS location as in 405, and updates his/her spatial temporal profile.

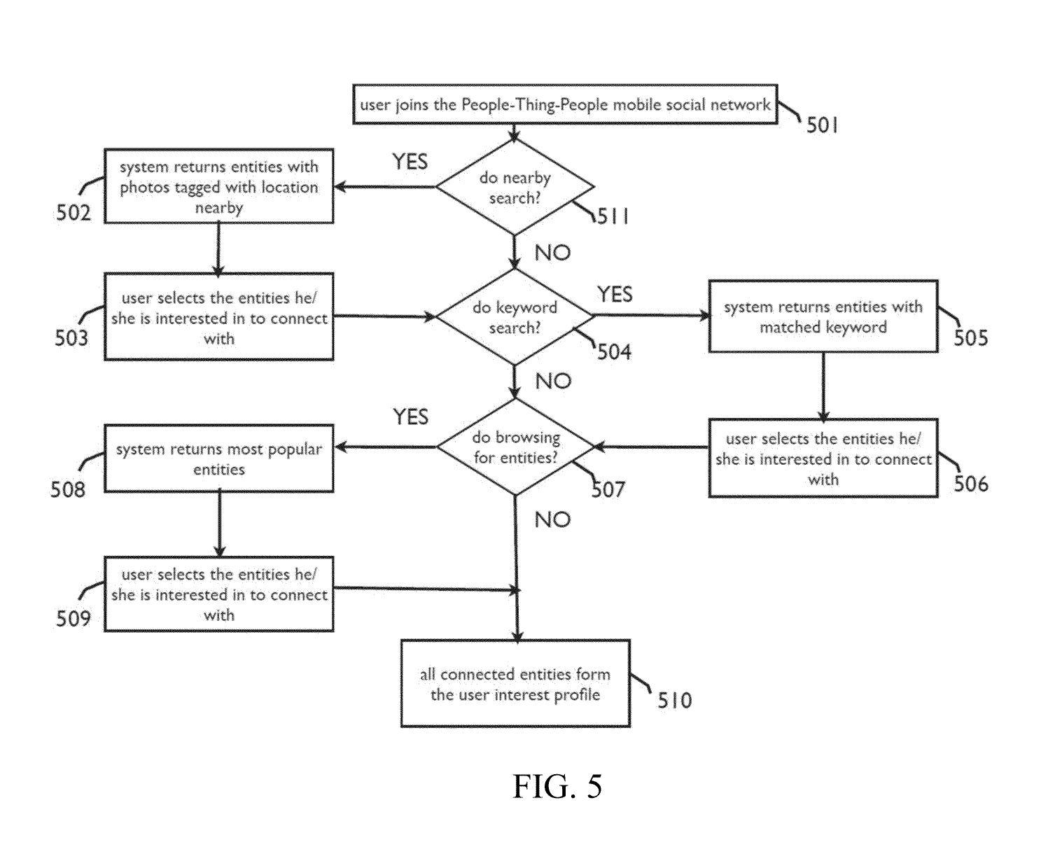

FIG. 5 is a flow chart showing the process of a user joining the People-Thing-People mobile social network. This process enables users to connect to entities they care about, by nearby search, by keyword search, and by browsing of popular entities. Referring to FIG. 5, in 501, the user would be asked to see if he/she would like to do a nearby search. If yes, the system would return entities with photos submitted with GPS location nearby as in 502, and the user can select the nearby entities that he/she is caring to connect with. After the nearby search, the user can also do a keyword search as in 504. The system would return entities with the matched keyword as in 505, and the user can select the entities to connect with as in 506. The user can then conduct a browsing of popular entities as in 508, and select entities to connect with as in 509. Finally, all connected entities, through different means, would form the user's Interest Profile as in 510.

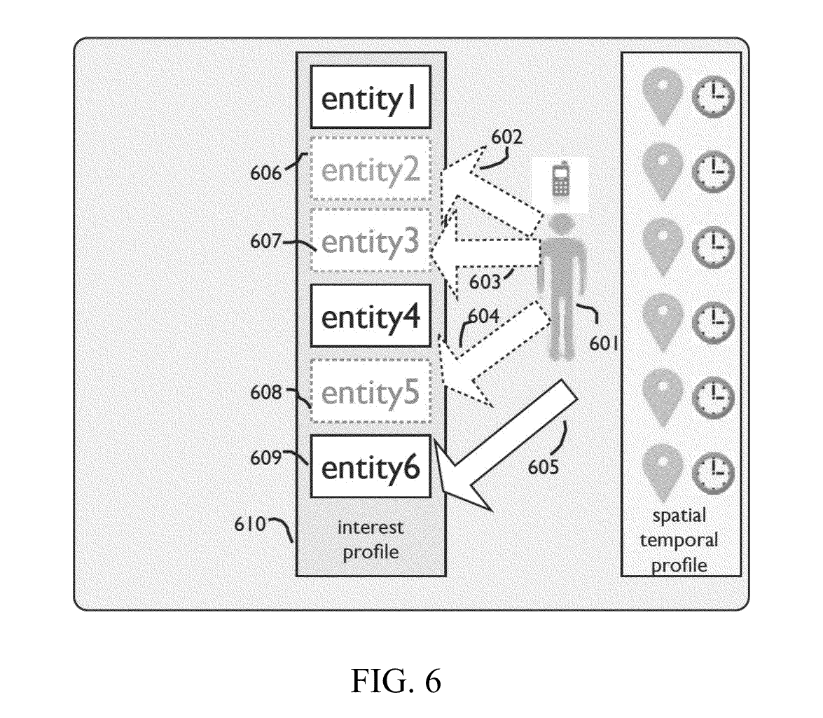

FIG. 6 illustrates how a user updates his/her Interest Profile, by removing and adding some relationships with things/entities. Referring to FIG. 6, the user 601 removes the relationship 602 with entity 606, removes the relationship 603 with the entity 607, removes the relationship 604 with the entity 608, and adds a new relationship 605 with the entity 609 on the People-Thing-People mobile social network. After these operations, his/her interest profile 610 would be updated to contain entities he/she has relationship with.

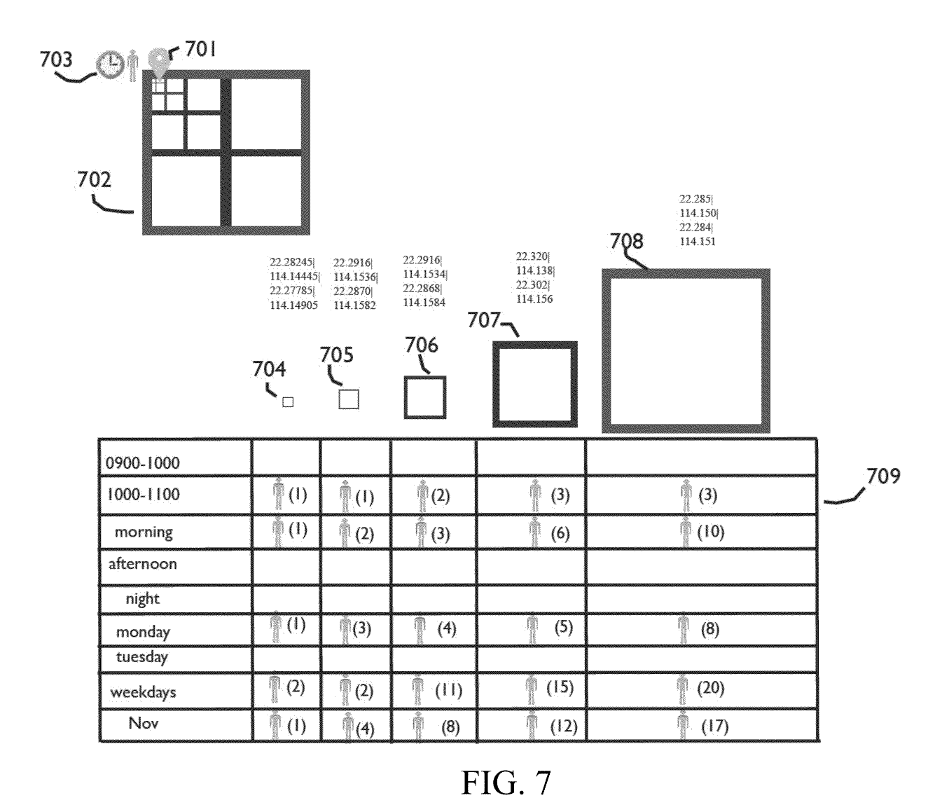

FIG. 7 illustrates an example of how a location and time entry is transformed into a specific format of People-to-Spatial Temporal relationships that facilitates efficient querying by the Backward Discovery Technology. Referring to FIG. 7, when the People-Thing-People mobile social network receives a report of the user's location and time, the location 701, specified by a pair of GPS x coordinate and GPS y coordinate, would be firstly transformed to a set of strings representing a set of grids with multiple resolutions 702. For example, a GPS location (22.285453,114.151618) would be transformed to a set of strings [‘22.282451114.14445122.277851114.14905’ (704), ‘22.29161114.1536122.28701114.1582’ 705, ‘22.29161114.1534122.28681114.1584’ (706), ‘22.3201114.138122.3021114.156’ (707), ‘22.2851114.150122.2841114.151’ (708)]. Also, the given time would be transformed to a given pre-defined set of time intervals. For example, 2012 Nov. 21 10:35:36 would be transformed to [‘1000-1100’, ‘morning’, ‘monday’, ‘weekdays’, ‘Nov’]. With these transformations, a single pair of location and time would update or insert multiple entries to the table 709, which record for each geographical grid and each pre-defined time interval, how many times users have accessed from that grid and within that time interval. In other words, this table 709 maintains the People-To-Spatial-Temporal Relationship and the frequency count, and facilitates an efficient querying for the Backward Discovery Technology when locating a group of users with specific Spatial Temporal Specification.

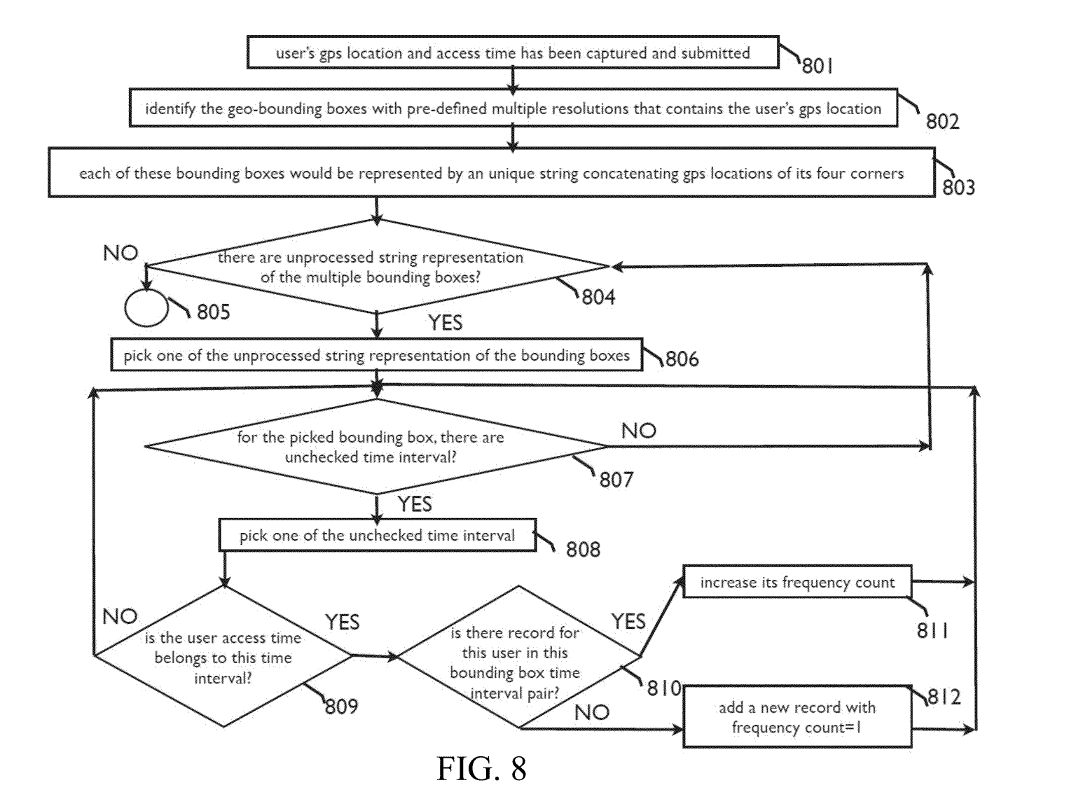

FIG. 8 is a flow chart showing how a given pair of user's current GPS location and access time is used to fill in the People-to-Spatial Temporal relationships with a frequency count. Referring to FIG. 8, in 801, after a user's current GPS location and access time has been captured and sent to the People-Thing-People mobile social network, the geographical bounding boxes with pre-defined multiple resolutions containing that GPS location would be identified as in 802. Each of these bounding boxes would be represented by a unique string concatenating GPS locations of its four corners as in 803. For each of these string representations of the bounding boxes as in 804 and 806, and for each of the pre-defined time interval as in 807 and 808, check if the user access time falls within the time interval. If it is as in 809, if there is already a record existing for this time interval for the user under this bounding box string representation as in 810, increase the frequency count of this record by 1 as in 811; otherwise add a new record for this user with this time interval under the bounding box string representation with frequency count=1 as in 812. Keep on checking all pre-defined time intervals and all bounding box string representation until all are checked as in 805.

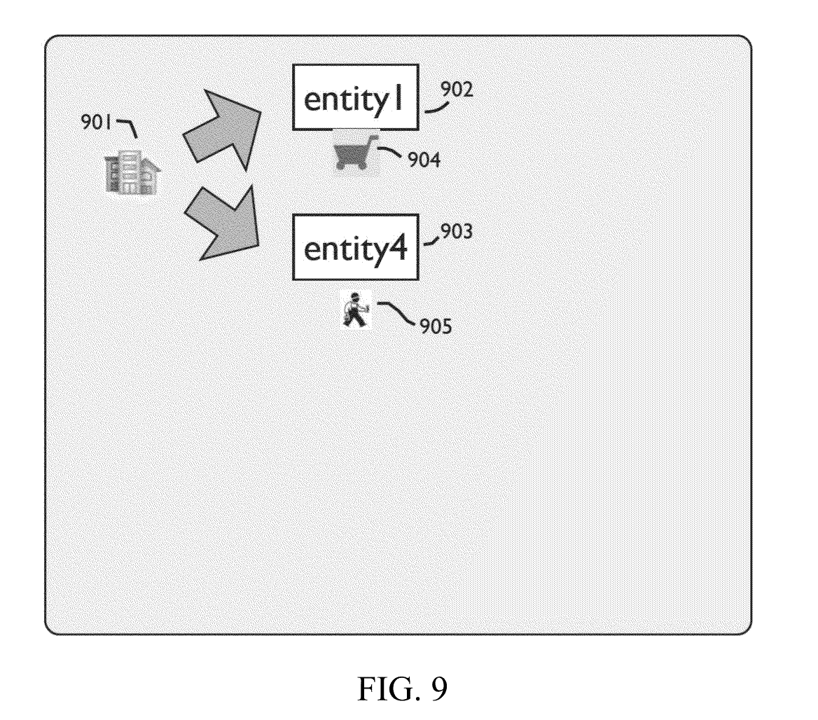

FIG. 9 shows that a merchant claims ownership of two entities which represent its real-world product/service. Referring to FIG. 9, an entity 902/903 on the People-Thing-People mobile social network represents a store 904/a specialized service 905 in the real world respectively. The merchant 901 owns the store 904 and provides the specialized service 905. On the People-Thing-People mobile social network, the merchant 901 can claim ownership of the entities 902 and 903.

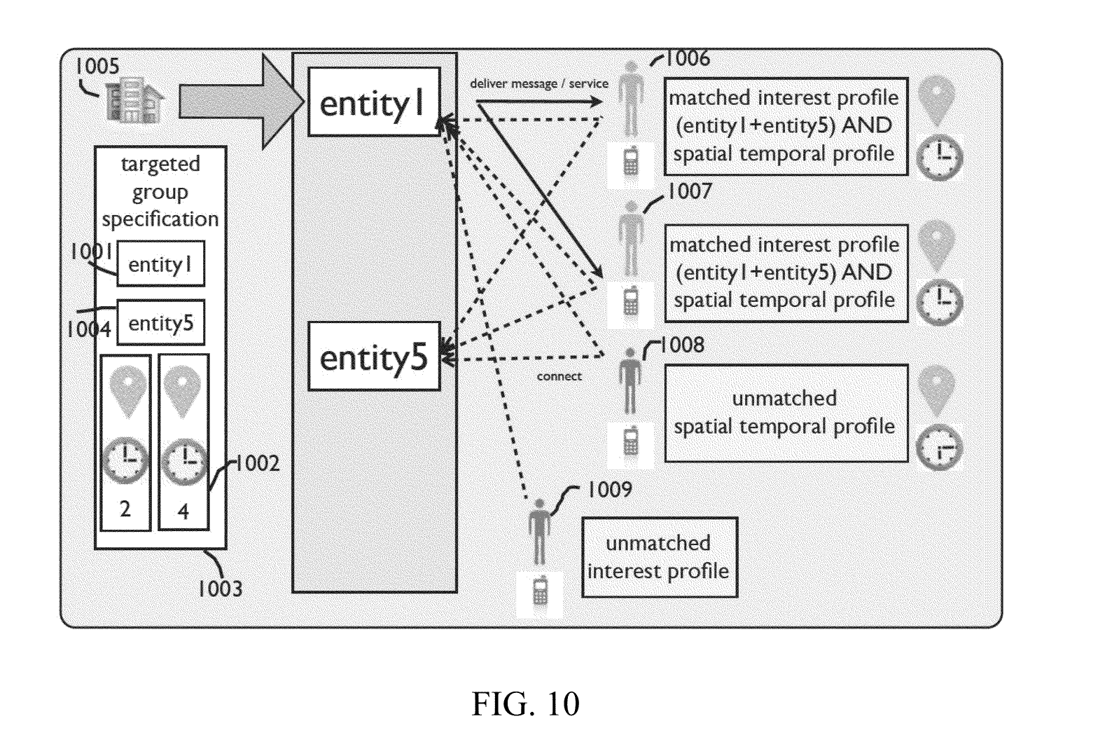

FIG. 10 shows how a target group specification can be formed with an Interest Profile specification and Spatial Temporal Specification by a merchant. With this specification, the merchant can, through its owned thing/entity, deliver message/service to the mobile devices of the users who have relationships with this entity, through notification or SMS. Referring to FIG. 10, a targeted group specification 1003 on the People-Thing-People mobile social network includes a set of entities (e.g. 1001 and 1004) which represent an Interest Specification, and a set of Spatial Temporal Specifications (e.g. 1002) each of which is represented by a geographical grid, a time interval, and a threshold value. A user is considered to be belonging to this targeted group specification, if all the entities in the specified Interest Profile have relationships with the user, and the user has appeared a number of times larger than the corresponding threshold value during the time interval matching one of the Spatial Temporal Specifications.

A merchant 1005 prepares a targeted group specification 1003, which must contains at least one of the entities in the Interest Profile Specification owned by the merchant on the People-Thing-People mobile social network. The merchant submits this specification and the Backward Discovery Technology would help to locate all users belonging to this targeted group specification, by an efficient querying on all users' Interest Profile and the table 1009. For example, the users 1006 and 1007 have relationships with entities 1001 and 1004, and they both appear for a number of times more than the specified threshold of one of the targeted Spatial Temporal Specifications. Therefore, the user 1006 and 1007 belong to the targeted group specification 1003 and would be located by the Backward Discovery Technology. The user 1008 also has relationships with the entities 1001 and 1004, however, he/she does not appear for a number of times more than the specified threshold of any one of the targeted Spatial Temporal Specifications. Therefore, the user 1008 does not belong to the targeted group specification 1003. The user 1009 does not have any relationship with the entity 1004 and thus does not belong to the targeted group specification 1003.

After identifying the targeted group of users for the specification by the Backward Discovery Technology, the People-Thing-People mobile social network would deliver the messages/services offered by the merchant 1005 to the users. By no means can the merchant 1005 know the identities of the users and the contacts of these users. When any one of these users decides to remove her/his relationship with the entity 1001 or 1004, this user shall never receive messages/services originated by merchant 1005 with the same targeted group specification 1003.

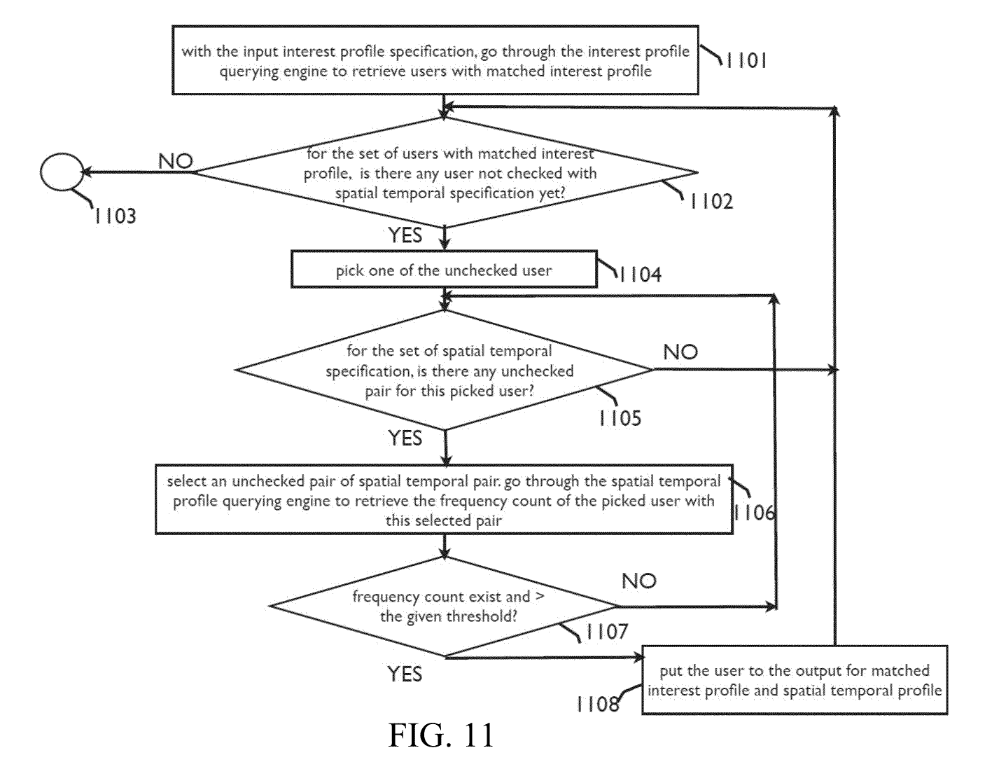

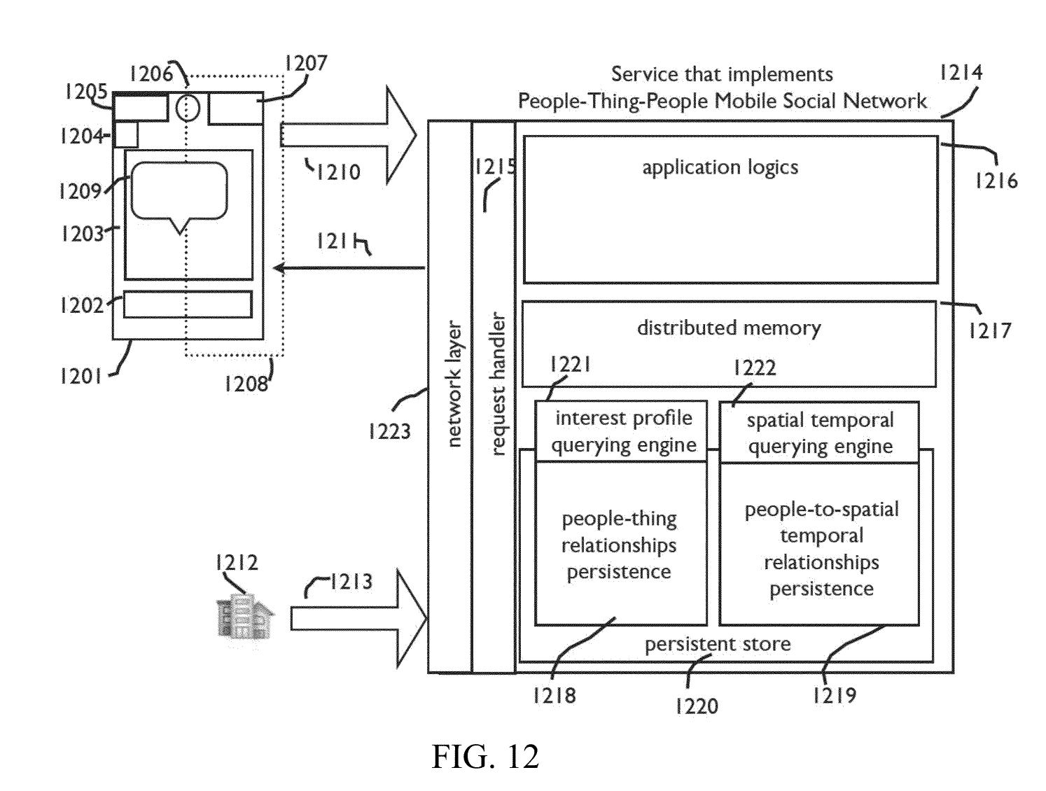

FIG. 11 is a flow chart showing the process of locating a group of users with matched Interest Profile and Spatial Temporal Profile according to the targeted group specification. Referring to FIG. 11, as in 1101, the Interest Profile Specification would be used to query the Interest Profile Querying Engine in 1221 (as shown in FIG. 12), which would return the set of users with the matched Interest Profile Specification. For each of these returned users as in 1102 and 1104, for each of the spatial temporal pair in the Spatial Temporal Profile Specification as in 1105, query the Spatial Temporal Profile Querying Engine in 1222. Check if there is a record and the frequency count of the record exceeds the given threshold in the Spatial Temporal Specification as in 1107. If it exists and the frequency count exceeds the threshold, put the user to the output result set with matched interest profile and spatial temporal profile, and go for next iteration of users with the matched Interest Profile, until all the matched users have been processed as in 1103.

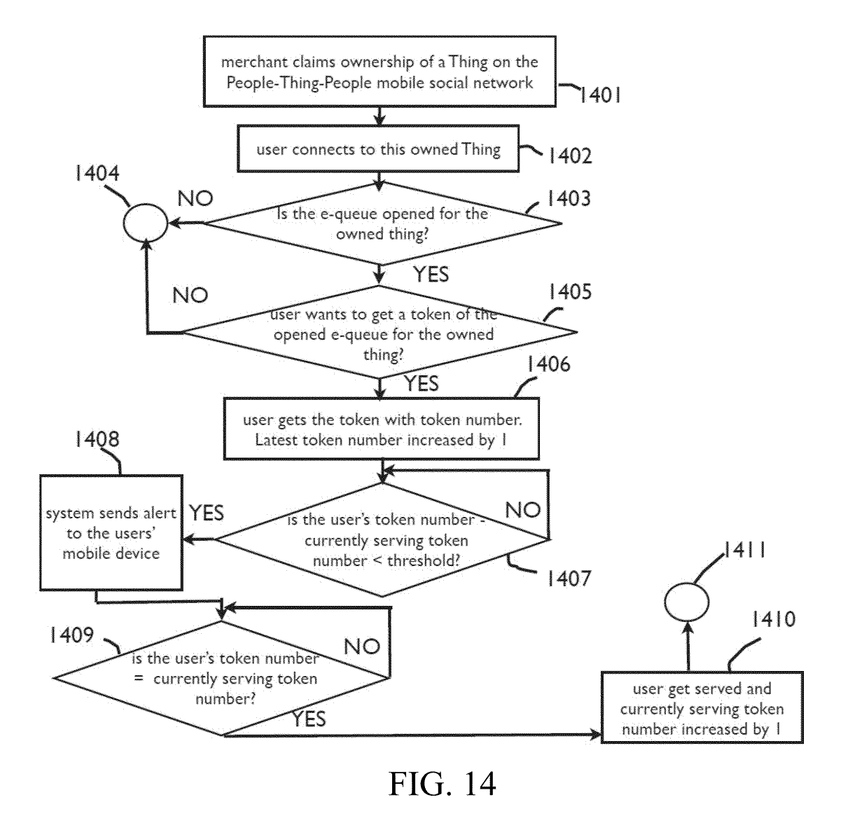

FIG. 12 shows the overall architecture for both the mobile device, and the service that implements the People-Thing-People Social Network. Referring to FIG. 12, a mobile device 1201 a user uses to access the People-Thing-People mobile social network includes a screen 1203 to show an output, an input interface 1202 for the user to control the mobile device for adding/removing relationships with different entities on the People-Thing-People mobile social network and to switch on/off its GPS capabilities, a clock 1204 to return correct time, a GPS device 1205 to return current GPS location, a camera 1206 for the user to take pictures and contribute to entities on the People-Thing-People mobile social network, a network component 1207 for the device to transmit and receive information from and to the service implementing the People-Thing-People mobile social network through a network connection 1210, and a mobile OS 1208 that coordinates all these activities. Each mobile device generates a unique ID, based on its unique hardware identifier or a phone number, and passes this ID to the People-Thing-People mobile social network. When there are messages/services from the People-Thing-People mobile social network targeted to a particular mobile device, which may include a promotional message or an alert sent by the e-queue system as in 1408 (as in FIG. 14), there will be a notification 1211 delivered to the device by the given unique ID through the mobile data network, or by the phone number through SMS. Upon receiving this notification 1211 through the mobile OS 1208, the notification will show up on the screen 1203 with a visual indicator 1209.

Referring to FIG. 12, the People-Thing-People mobile social network can be implemented as a service 1214 in a dedicated host, or a cloud computing platform, with the following components: a network layer 1213 that sends and receives data to and from the Internet, a request handler 1215 that receives and parses requests from the user through their mobile device 1201 or from the merchant 1212, an application logics layer 1216 that bases on the current status and the request to decide the consequences, a main memory 1217 that stores data required in computation or caching, and a persistence store 1220 that physically stores all the captured and computed data and provides the indexing and querying functionalities. Inside the persistence store 1220, there are two main tables. 1218 stores all the relationships between people and entities, and 1221 provides an efficient querying engine to get the users having relationships with a given set of entities. 1219 maintains all the people-to-spatial temporal relationships and the corresponding frequency counts as in 709, and 1222 provides an efficient querying engine to get users matching any one Spatial Temporal pair in the given Spatial Temporal Specification with frequency counts larger or equal to the given threshold value.

The merchant 1212, through a web interface or another mobile application, can send a targeted group specification, together with the messages/services it would like to deliver to the belonging users, through the network connection 1213 to the service 1214 that implements the People-Thing-People Mobile Social Network.

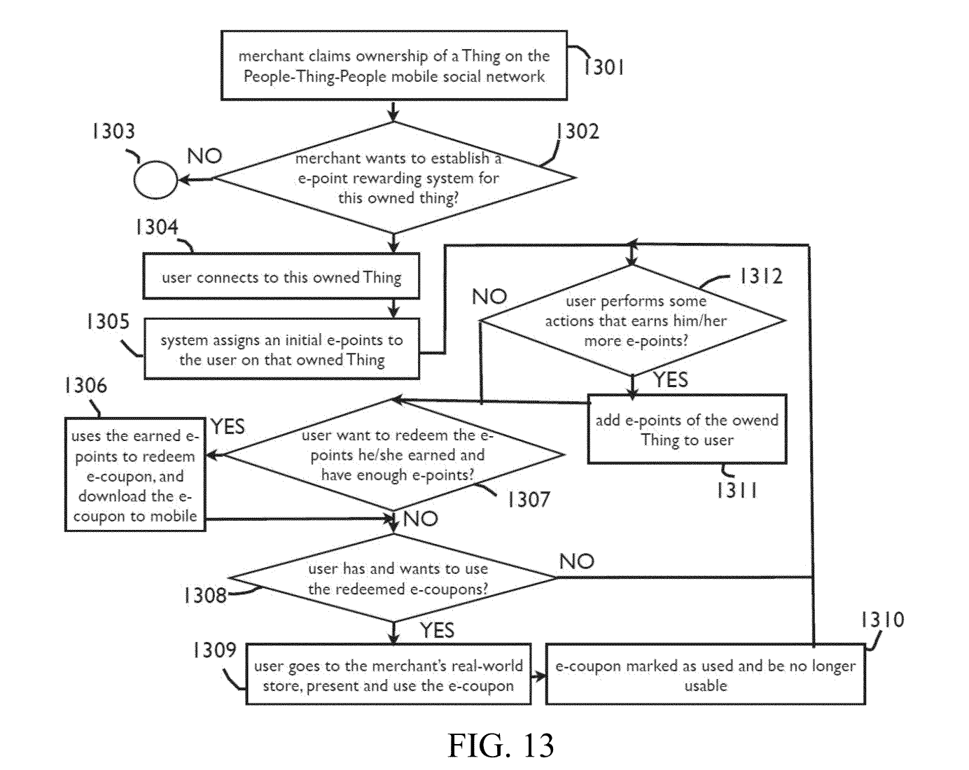

FIG. 13 is a flow chart showing the process for a user, who has connected to a Thing owned by a merchant, to join the e-point rewarding system, earn e-points through different activities on the People-Thing-People social network, or through making real purchases, use the earned e-points to redeem e-coupons, and then use the e-coupons to get products or services in the merchant real-world store. Referring to FIG. 13, in 1301, a merchant claims the ownership of a Thing on the People-Thing-People mobile social network. After that, the merchant can decide whether to establish the e-point rewarding system for this owned Thing as in 1302. If the merchant decides to do so, and when a user connects to this Thing on the People-Thing-People mobile social network as in 1304, the system would assign an initial e-point to the user on that owned Thing as in 1305. Whenever the user performs some actions related to that owned Thing on the People-Thing-People mobile social network, or does any actual purchase of products or services as in 1312, he/she can earn some more e-points as in 1311.

If the user gets enough e-points and he/she wants to use the earned e-points to redeem e-coupons for that owned Thing as in 1307, he/she can do so and the redeemed e-coupon will be downloaded to the user's mobile device as in 1306.

When the user wants to use the e-coupons as in 1308, he/she would go to the merchant's real-world store, present the e-coupon to the merchant and use the e-coupon as in 1309. After being used, the e-coupons will be marked as used by the system, and cannot be used anymore as in 1310.

FIG. 14 is a flow chart showing the process for a user, who has connected to a Thing owned by a merchant, to get a token to queue up in the opened e-queue for that Thing, to receive notifications about when it is his/her turn to be served, and to present the token to the merchant real-world store to get served when it is his/her turn. Referring to FIG. 14, as in 1401, a merchant claims the ownership of a Thing on the People-Thing-People mobile social network. When a user connects to that owned Thing as in 1402, if the merchant has opened an e-queue for that owned Thing as in 1403, and the user wants to queue-up for the opened e-queue to get served as in 1405, he/she will get a e-queue token with a token number from the system and download this token to his/her mobile device as in 1406. In the system, the latest token number will be increased by 1.

When the token number currently being served is smaller than the user's token number and the difference is within a certain threshold value as in 1407, the system will send an alert, in the form of notification as in 1211, to the user's mobile device as in 1408.

When the token number currently being served is equal to the user's token number, another alert is sent to the user and the user can present the token in the merchant's real-world store and get served as in 1410. The currently served token number will then be increased by 1.

In the above embodiments, to eliminate the conflict between the marketers and the users, for a particular piece of marketing information, a People-Thing-People social network can apply Backward Discovery Technology to identify group of users who are interested in or looking for this piece of information.

Normal Forward Search is for the users to locate information they need. For Backward Discovery, it is for the information owner to locate the group of users who are interested in getting this piece of information.

Backward Discovery Technology relies on two pieces of information from users on the People-Thing-People mobile social network. 1. The user Interest Profile, which is the set of entities (things) the user is interested in and has built relationships with. 2. The user's Spatial Temporal Profile, which is collected and built when the user accesses the People-Thing-People mobile social network through his/her GPS-enabled mobile device.

When the user adds or removes relationships with things/entities inside the People-Thing-People mobile social network, naturally these form the user Interest Profile which tells others what the user likes and cares. The user can keep on updating these relationships anytime in the system.

The user accesses the People-Thing-People mobile social network through mobile devices with GPS capabilities. When the user enables the GPS capabilities, whenever the user accesses the People-Thing-People mobile social network, the mobile device would collect the current user's location as GPS coordinates, and send it with the current time to the People-Thing-People mobile social network.

Upon receiving the reported location and time from the mobile device, the system would transform them into a specific format representing geographical grids with multiple resolutions, and also time intervals with multiple resolutions. Such representation facilitates efficient querying when being used by the Backward Discovery Technology.

Merchants can pay and claim ownership of a thing/entity existing in the People-Thing-People mobile social network, which is representing them, or their product or service, legally in the real-world, through a verification process.

Through the owned thing/entity, the merchants can specify a targeted group of users, characterized by a given Interest Profile which must contain the owned thing/entity, and a Spatial Temporal Profile. With this targeted group specification, the merchants can send marketing material, promotional messages, or deliver services to the users having relationship with this thing/entity, through the notification/SMS service to the users' mobile devices, without the identity and the contact of the users being known to the merchants.

The users can decide whether to receive those messages and services, by choosing whether to maintain the relationship with that thing/entity. Since the identity and the contact of the users would not be revealed, if the user remove his/her relationship with that thing/entity, those messages and services targeted by that thing/entity would not be reaching the user again.

The merchant can establish a membership system on the owned thing/entity for its connected users. The users can earn e-points through different activities on the PTP mobile social network, or actual purchase related to that owned thing/entity, and can use the earned e-points to redeem e-coupons. If users are disconnected from that owned thing, their earned e-points would be discarded but the redeemed e-coupons would be retained.

Upon getting the e-coupons of the owned thing, the users can go to the real-world store of the merchant to present and use the e-coupons for getting discounts, products or services.

The merchant can establish an appointment and e-queuing service on the owned thing for its connected users. The users can make appointments through the owned thing and the merchant can confirm or reject such appointments.

When merchants open an e-queue for the owned thing, connected and interested users can each get an e-queue token with a token number. Users can get real-time updates or notifications for the latest token number being served through the mobile device. The users can present the e-queue token in the merchant real-world store to get served when it is his/her turn with the token number.

While the present patent application has been shown and described with particular references to a number of embodiments thereof, it should be noted that various other changes or modifications may be made without departing from the scope of the present invention.

What is claimed is:

1. A method for delivering information to a targeted group of users, the method comprising:
establishing a network that comprises a plurality of users and a plurality of entities being connected with each other based on the interest of the users in the entities;
searching for a targeted group of users who match a specification of an interest profile and a specification of a spatial temporal profile among the users in the network; and
delivering information to the targeted group of users; wherein:
the interest profile is based on the relationships between each user and the entities that the user is interested in; and
the spatial temporal profile is based on the location and the time on which the user accesses the network.

2. The method of claim 1 further comprising claiming ownership of an owned entity within the network.

3. The method of claim 2 further comprising establishing a targeted group specification, wherein the targeted group specification comprises the specification of the interest profile and the specification of the spatial temporal profile, and the entities in the specification of the interest profile comprise an owned entity.

4. The method of claim 3, wherein if a user has relationships with all entities in the specification of the interest profile, then the user matches the specification of the interest profile.

5. The method of claim 3, wherein the specification of the spatial temporal profile is represented by a geographical grid, a time interval, and a threshold value.

6. The method of claim 5, wherein if a user has accessed the network at the geographical grid during the time interval for a number of times that is equal to or greater than the threshold value, then the user matches the specification of the spatial temporal profile.

7. The method of claim 2 further comprising assigning an electronic credit to a user connected to the owned entity.

8. The method of claim 7 further comprising assigning an additional electronic credit to the user if the user performs a predetermined action.

9. The method of claim 2 further comprising assigning a queue token with a token number to a user connected to the owned entity.

10. The method of claim 9 further comprising sending an alert to the user when the difference between the token number currently being served and the token number of the user is within a predetermined threshold.

11. The method of claim 10 further comprising sending another alert to the user when the token number currently being served is equal to the user's token number.

12. A system for delivering information to a targeted group of users, the system comprising:
a first persistence store configured to store relationships between a plurality of users and a plurality of entities forming a network;
a second persistence store configured to store the location, the time, and the number of times for each of the users accessing the network;
a first engine and a second engine respectively configured to search for a group of users who match a specification of an interest profile and a specification of a spatial temporal profile in the network; and
a network layer configured to deliver information to a targeted group of users; wherein:
the targeted group of users match both the specification of the interest profile and the specification of the spatial temporal profile;
the interest profile is based on the relationships between each user and the entities that the user is interested in; and
the spatial temporal profile is based on the location and the time on which the user accesses the network.

13. The system of claim 12, wherein the specification of the interest profile comprises at least one owned entity owned by a merchant.

14. The system of claim 13, wherein if a user has relationships with all entities in the specification of the interest profile, then the user matches the specification of the interest profile.

15. The system of claim 12, wherein the specification of the spatial temporal profile is represented by a geographical grid, a time interval, and a threshold value.

16. The system of claim 15, wherein if a user has accessed the network at the geographical grid during the time interval for a number of times that is equal to or greater than the threshold value, then the user matches the specification of the spatial temporal profile.

17. The system of 13 further comprising a logic unit configured for executing logics and a distributed memory configured for storing data required in computation or caching.

18. The system of 17, wherein the logic unit is configured to assign an electronic credit to a user connected to the owned entity.

19. The system of claim 18, wherein the logic unit is configured to assign a queue token with a token number to a user connected to the owned entity.

20. A computer-readable medium storing thereon one or more instructions, which when implemented causes a processor to implement a method for delivering information to a targeted group of users, the method comprising:
establishing a network that comprises a plurality of users and a plurality of entities being connected with one another based on the interest of the users in the entities;
searching for a targeted group of users who match a specification of an interest profile and a specification of a spatial temporal profile among the users in the network; and
delivering information to the targeted group of users; wherein:
the interest profile is based on the relationships between each user and the entities that the user is interested in; and
the spatial temporal profile is based on the location and the time on which the user accesses the network.
